(19) United States
(12) Patent Application Publication
(10) Pub. No.: US 2016/0262404 A1
(43) Pub. Date: Sep. 15, 2016

(54) Pesticide Compositions Containing Thyme Oil and Cinnamon Oil

(71) Applicant: Steven R. Sims, St. Louis, MO (US)

(72) Inventor: Steven R. Sims, St. Louis, MO (US)

(73) Assignee: BASF Coporation, Florham Park, NJ (US)

(21) Appl. No.: 14/128,086

(22) PCT Filed: Jun. 22, 2012
(86) PCT No.: PCT/US2012/043661

§ 371 Date: Mar. 22, 2016

Related U.S. Application Data
(60) Provisional application No. 61/500,453, filed on Jun. 23, 2011.

(51) Int. Cl. A01N 65/24; A01N 65/22

(52) U.S. Cl. CPC A01N 65/24; A01N 65/22

(57) ABSTRACT

Pesticide compositions and methods of controlling insects and other pests are disclosed. Generally, the pesticide compositions contain thyme oil and cinnamon oil as their principal active ingredients which, when used in combination, act synergistically to control pests such as crawling insects.

### BACKGROUND

The present disclosure relates to pesticide compositions and methods of controlling insects and other pests. More particularly, the disclosure relates to pesticide compositions containing thyme oil and cinnamon oil as their principal active ingredients which, when used in combination, act synergistically to control pests such as crawling insects.

Insects and other arthropod pests can have negative effects on the quality of human life. For instance, when found in the home, insects and other arthropods can be a source of annoyance due purely to their presence. They may also spread disease and allergens. Additionally, when found on plants and crops, insects and other pest arthropods can destroy foliage and fruit, and may adversely affect plant and crop growth, quality, and yield.

Among the insects which are particularly undesirable are domestic cockroaches. These insects produce allergens in their saliva, fecal material, cast skins and body parts which may be particularly problematic for people suffering from allergies.

It is domestically and commercially desirable to control cockroaches through the use of pesticide products. It is also desirable to control other crawling arthropods, such as ants, beetles, earwigs, silverfish, crickets, spiders, pillbugs, sowbugs, centipedes, firebrats and the like.

A broad range of compounds are toxic to insects and other arthropods and formulations containing these compounds may be used for their control. However, most compounds damage the environment and adversely affect human health. There is a need for new pesticides which are generally safe to the environment (such as active ingredient compounds on the FDA's 25b exempt list) and non-toxic to humans and animals and which are effective at controlling insect and other pest populations.

### SUMMARY

One aspect of the present disclosure is directed to a pesticide composition for use in killing crawling insects. The concentrate pesticide composition comprises a plurality of active ingredients including a first active ingredient and a second active ingredient. The first active ingredient is selected from thyme oil, thymol, carvacrol and mixtures thereof The second active ingredient is selected from cinnamon oil, eugenol, cinnamic aldehyde and mixtures thereof At least about 33 wt % of the active ingredients are one or more first active ingredients and one or more second active ingredients.

Another aspect of the present disclosure is directed to a method for controlling crawling insects. A pesticide composition is applied to a crawling insect. The pesticide composition comprises a plurality of active ingredients including a first active ingredient and a second active ingredient. The first active ingredient is selected from thyme oil, thymol, carvacrol and mixtures thereof The second active ingredient is selected from cinnamon oil, eugenol, cinnamic aldehyde and mixtures thereof. At least about 33 wt % of the active ingredients are one or more first active ingredients and one or more second active ingredients. The composition is capable of killing crawling insects after contact.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is an isobologram demonstrating synergy between thyme oil and cinnamon leaf oil for two pesticide compositions in accordance with Example 1.

### DETAILED DESCRIPTION

In accordance with the present disclosure, it has been found that the combination of thyme oil and cinnamon is effective for use in controlling insect and other pest populations. In particular, it has been discovered that compositions comprising both thyme oil and cinnamon oil are more effective in controlling arthropods than compositions containing only thyme oil or cinnamon oil alone, i.e., thyme oil and cinnamon oil act in a synergistic manner such that their effectiveness when used in combination exceeds the additive effectiveness when cinnamon oil and thyme oil are used individually.

In this regard, the pesticide compositions of the present disclosure may be a concentrate composition which is diluted by the end user prior to use by, for example, addition of water. It should be noted that any reference herein to the percentage inclusion of components in a pesticide composition are made with reference to the concentrate composition unless stated otherwise. For purposes of the present disclosure, “concentrate” pesticide compositions contain less than about 3% water and, more typically, contain essentially no amount of water. Rates of dilution (i.e., ratio of concentrate to water ratio by volume) for the pesticide compositions of the present disclosure may be at least about 1:64, at least about 1:32, at least about 1:16, at least about 1:8 or at least about 1:4 (e.g., from about 1:128 to about 1:4 or from about 1:96 to about 1:16).

The pesticide compositions of the present disclosure contain at least two active ingredients—a first active ingredient selected from thyme oil or one or more of the major constituents of thyme oil such as thymol, carvacrol and a second active ingredient selected from cinnamon oil or one or more of the major constituents of cinnamon oil such as eugenol or cinnamic aldehyde. The compositions may contain other active ingredients and, in particular, may contain other essential oils. Generally, the first active ingredient (e.g., thyme oil or component thereof) and the second active ingredient (e.g., cinnamon oil or component thereof) make up at least about 33 wt % of all active compounds. In some embodiments, at least about 50 wt % of the active ingredients in the composition are one or more first active ingredients and one or more second active ingredients or at least about 75 wt % or even at least about 90 wt % of the active ingredients in the composition are one or more first active ingredients and one or more second active ingredients. In some particular embodiments, the active ingredients in the composition consist essentially of thyme oil and cinnamon oil (e.g., the composition contains only thyme oil, cinnamon oil, derivative compounds of these oils or minor amounts of active compounds that may be found in refined or unrefined cinnamon oil or thyme oil) or even consist of thyme oil and cinnamon oil.

In various embodiments of the present disclosure and particularly in embodiments wherein the composition is a concentrate (e.g., contains less than about 3 wt % water or essentially no amount of water), the total amount of active ingredients (e.g., thyme oil and cinnamon oil and any other active ingredients) in the composition may be at least about 15 wt % of the compositions. In other embodiments of the present disclosure, the pesticide composition comprises at least about 20 wt % total active ingredients or at least about 35 wt %, from about 15 wt % to about 75 wt %, from about 15 wt % to about 60 wt % or from about 20 wt % to about 50 wt % total active ingredients. In these and in other embodiments, the composition (e.g., concentrate composition containing less than about 3 wt % or essentially no water) may contain at least about 3 wt % first active ingredients (e.g., thyme oil) or at least about 5 wt %, at least about 7.5%, from about 3 wt % to about 40 wt %, from about 3 wt % to about 25 wt % or from about 7.5 wt % to about 15 wt % first active ingredients (e.g., thyme oil). The composition may also contain at least about 10 wt % second active ingredients (e.g., cinnamon oil) or at least about 20 wt %, at least about 25 wt %, from about 10 wt % to about 60 wt %, from about 20 wt % to about 50 wt % or from about 25 wt % to about 40 wt % second active ingredients (e.g., cinnamon oil).

The relative proportions of the first active ingredient (e.g., thyme oil) and the second active ingredient (e.g., cinnamon oil) may vary without departing from the scope of the present disclosure. In one or more embodiments, the weight ratio (either in the concentrate or in a diluted form of the compositions) of first to second ingredients (e.g., thyme oil to cinnamon oil) is at least about 1:8, at least about 1:6 or at least about 1:4. In these and other embodiments, the weight ratio of first to second active ingredients is less than about 2:1, less than about 4:3, less than about 1:1 or even less than about 1:2. Further, the weight ratio of first to second active ingredients (e.g., thyme oil to cinnamon oil) may be bound by any combination of the above noted parameters such as, for example, from about 1:8 to about 2:1 or from about 1:6 to about 1:1.

In this regard, “thyme oil” as used herein refers to any oil that is derived from thyme including purified and/or refined derivatives of thyme oil. Thyme oil may be derived from Thymus vulgaris and any of its cultivars or from another species of Thymus. Thyme oil may be extracted from any other known species of thyme without limitation. Thyme oil may be extracted by any method suitable to those of skill in the art for extracting such oils such as, for example, steam distillation. Without being bound to any particular constituents, thyme oil may include one or more known chemical compounds such as, for example, thymol and/or its isomer, carvacrol, as well as geraniol, p-cymene, terpinene and/or β-caryophyllene. Other minor components of thyme oil may include, for example, α-thujone, borneol, α-pinene, camphene, β-pinene, terpineol and/or linalool. If thymol or carvacrol is used as an alternative or in addition to thyme oil, the thymol or carvacrol may be derived from thyme oil or thymol or carvacrol may be produced synthetically or may be derived from other sources including other essential oils. In this regard, “cinnamon oil” as used herein refers to any oil that is derived from cinnamon leaves or from cinnamon bark including purified and/or refined derivatives of cinnamon oil. Cinnamon oil, and particularly cinnamon leaf oil, may be derived from Cinnamomum zeylanicum (also known as C. verum) or from Laurus cinnamomum. Other species of cinnamon from which oil may be derived (either from the bark or leaf) include C. burmannii, C. loureiroi and C. aromaticum. Cinnamon oil may be extracted from any known species of cinnamon without limitation. Cinnamon oil may be extracted by any method suitable to those of skill in the art for extracting such oils such as, for example, steam distillation. It should be noted that cinnamon oil may include amounts of oil derived from other parts of cinnamon including cinnamon twigs and/or the plant as a whole. For purposes of the present disclosure, in addition to specific use of the bark or leaf, “cinnamon oil” includes oil that is extracted from the plant in its entirety (i.e., the entire plant is ground and oil is extracted from the ground plant). Typically, the principal component of cinnamon leaf oil is eugenol. Other components that may be present include, for example, eugenol acetate, cinnamic aldehyde and benzyl benzoate. Typically the principal component of cinnamon bark oil is cinnamic aldehyde. If eugenol or cinnamic aldehyde is used as an alternative or in addition to cinnamon oil, the eugenol or cinnamic aldehyde may be derived from cinnamon oil or may be produced synthetically or may be derived from other sources including other essential oils.

In this regard, it has been found that, in certain embodiments of the present disclosure, thyme oil and cinnamon oil-containing pesticide compositions (or compositions which contain one or more components of thyme oil or cinnamon oil) may exhibit synergistic properties (i.e., the lethal effect of the composition exceeds the additive effect that is expected based on the lethality of thyme oil and cinnamon oil used separately). As shown in Examples 1 and 2, the composition has been found to exhibit synergy at weight ratios of thyme oil to cinnamon oil of less than about 1:1 (e.g., from about 1:6 to about 1:1). In this regard, the composition may exhibit synergy at ratios other than as recited above (such as thyme oil to cinnamon oil weight ratios of above about 1:1 or less than about 1:6) and the recited ratios should not be considered to be limiting.

In addition to thyme oil and cinnamon oil (or components thereof) and any other active ingredient, the pesticide composition of the present disclosure may include other components which act as improve one or more characteristics of the composition. For instance, the composition may include one or more components that improve the distribution of thyme oil and/or cinnamon in the diluted composition (e.g., surfactants and/or co-solvents). In some embodiments of the present disclosure, the concentrate composition includes a surfactant to prevent the thyme oil and/or cinnamon oil from forming relatively large globules in the diluted composition. Suitable surfactants include most fatty acids. In particular, coconut oil (synonymously “coconut fatty acid” or “coconut fatty acid soap”) has been found to be a suitable surfactant. In various embodiments of the present disclosure, the concentrate composition may include at least about 15 wt % surfactant, at least about 20 wt % surfactant, at least about 25 wt % surfactant or at least about 40 wt % surfactant (e.g., from about 15 wt % to about 70 wt % or from about 25 wt % to about 60 wt % surfactant). The weight ratio of surfactant to active ingredients in the concentrate or diluted composition may be at least about 1:5, at least about 1:3, at least about 1:2 or at least about 1:1 (e.g., from about 1:5 to about 2:1 or from about 1:3 to about 3:2).

The pesticide composition may include components other than surfactants which act to distribute the active components throughout the diluted composition. For example, the composition may include one or more co-solvents (i.e., a material that increases the solvent capacity of the primary solvent (e.g., water) and/or that increases the distributive effect of the surfactant). Suitable co-solvents include C1 to C10 alcohols and, in particular, propanol and/or isopropyl alcohol. Isopropyl alcohol has been found to be an effective co-solvent according to some embodiments of the present disclosure. In certain embodiments of the present disclosure, the concentrate composition includes at least about 5 wt % co-solvent, at least about 10 wt %, from about 5 wt % to about 35 wt % or from about 10 wt % to about 25 wt % co-solvent. In these and other embodiments, the weight ratio of co-solvent to active ingredients is at least about 1:5, at least about 1:4, at least about 1:3 or at least about 1:2 (e.g., from about 2:1 to about 1:5 or from about 1:1 to about 1:3).

In this regard, it should be noted that the composition after dilution does not form a homogeneous “solution” as that term may be recognized by those of skill in the art. The diluted composition, at least in some embodiments of the present disclosure, forms an emulsion (typically a micro-emulsion) in which cinnamon and thyme oil are dispersed in an aqueous continuous phase. It should be understood that any reference herein to a “solvent” (e.g., water being used as a solvent upon dilution), “co-solvent” or even “solution” should not be considered to exclude such emulsions and these terms should not be considered in a limiting sense.

The pesticide compositions of the present disclosure may also contain additional functional components other than as previously recited such as, for example, preservatives, emulsifiers, dispersants and/or synergists. In some embodiments, all of the components of the pesticide composition are on the FDA's exempt list. However, in other embodiments one or more components are not on the exempt list (e.g., solvents, co-solvents or surfactants). In this regard, the components of the composition as listed herein are not exclusive unless stated otherwise and other components including other pesticidally effective components may be included without limitation.

In this regard, the pesticide compositions of the present disclosure may be used to control a variety of insects and, in particular, arthropods such as, for example ants (e.g., red imported fire, southern fire or carpenter), cockroaches (e.g., American, German, Asian or Oriental), firebrats, bees (e.g., honey and carpenter), beetles (e.g., Japanese, maize weevil, confused flour, sawtoothed grain, rice weevil or granary weevil), mosquitoes (e.g., southern house or yellow fever), pillbugs, sowbugs, centipedes, millipedes, yellowjackets, earwigs, houseflies and spiders. In one or more particular embodiments of the present disclosure, the pesticide composition is used to control (i.e., kill) crawling insects such as, for example, cockroaches, ants, beetles, earwigs, spiders, pillbugs, sowbugs, centipedes, millipedes, firebrats, silverfish, crickets and the like. The pesticide compositions of the present disclosure are particularly effective against cockroaches, including the species Periplaneta americana (American cockroach), Blattella germanica (German cockroach), Blattella asahinai (Asian cockroach), and Blatta orientalis (Oriental cockroach).

Generally pesticide compositions having the above noted amounts of thyme oil and cinnamon oil are capable of killing the recited arthropods at typical dilution rates; however, it should be understood that active ingredient inclusion rates other than as recited may be used without limitation. Selection of the active ingredient inclusion rate and the dilution rate may depend on a variety of factors (e.g., target pest species, desired speed of lethal action, active ingredient costs and the like) and is generally within the capabilities of those of ordinary skill in the art.

In embodiments wherein the pesticide composition is a concentrate composition, the composition is diluted before use with dilution typically being performed by the end user (e.g., in a pump spray bottle). The composition may be diluted by addition of water at the site of use (e.g., residential or commercial site). When used by a pest control professional, the composition may alternatively be diluted at the place of business of the professional. Alternatively and in some embodiments, the pesticide composition is a ready-to-use composition that is not diluted prior to use.

The pesticide compositions of the present disclosure may be dispensed in any conventional manner (e.g., from a standard pump-spray container). In some embodiments, the pesticide composition is charged to a pressurized container such as a conventional aerosol container or the like. The composition may be pressurized utilizing any suitable propellant. Examples of suitable propellants include expandable gases such as carbon dioxide, nitrogen, propane, n-butane, isobutane, blends of propane and butane, HFC-152a (difluoroethane), HFC-134a (1,1,1,2-tetrafluoroethane), and combinations thereof Other examples of suitable propellants which may be used are known in the art and include, for example, dimethyl ether, methyl ethyl ether, nitrous oxide, and the like. Typically the composition will comprise propellant in an amount of from about 2 wt % to about 90 wt % of the composition and more typically in an amount of from about 2 wt % to about 10 wt % of the composition. Containers in which the composition is stored should be resistant to corrosion upon exposure to the composition and should allow for relatively long-term storage of the composition. Suitable contains may be composed of or may be lined with, for example, fluorinated high density polyethylene.

As noted above, the pesticide compositions of the present disclosure may be sprayed or otherwise contacted with insects or other pests to effectively control insect or other pest populations. Thus, in some embodiments, the present disclosure is directed to a method of controlling insects (e.g., crawling arthropods) or other pests. The method includes applying the pesticide composition (preferably with at least about 33 wt % and more preferably with 100 wt % of the active ingredients being thyme oil and/or cinnamon oil) to a target pest. The composition as applied is capable of killing the insect after contact with the composition.

Generally, the pesticide compositions of embodiments of the present disclosure are contact pesticides that are directly applied to an insect or insect population. However, pesticide compositions of the present disclosure should not be limited to such applications and in some embodiments, the pesticide composition may be used as a fumigant in which one more components are in gaseous form upon contacting the insect or a residual pesticide in which one or more components contact the insect after several seconds, minutes or even hours after application of the composition. The amount of the pesticide composition required to kill insects or other pests and the time until pest death will vary depending on the composition components, the type of insect species and its life stage, and the like. The time required to kill a pest contacted with a pesticide composition of the present disclosure will typically range from mere minutes to several hours.

In some embodiments, an arthropod is contacted with the pesticide composition in a pesticidally effective amount of the composition. For purposes of the present disclosure, a “pesticidally effective amount” of the composition includes amounts that repel the arthropod or other pest and may include, in other embodiments, amounts of the composition that kill the arthropod or other pest (e.g., is capable of killing at least 50% of one or more particular pests (e.g., cockroaches) that contact the composition.

Without being bound to any particular degree of mortality, the pesticide compositions of the present disclosure may generally result in at least 33% mortality of one or more insects species (e.g., crawling arthropods) that contact the composition within 24 hours of application or at least about 50% mortality, at least about 75% mortality, at last about 90% mortality, at least about 95% mortality, and even about 100% mortality of one or more insects species that contact the composition within 24 hours of application.

### EXAMPLES

The processes of the present disclosure are further illustrated by the following Examples. Accordingly, these Examples should not be viewed in a limiting sense.

### Example 1

### Determination of Synergy at Various Active Ingredient Ratios

The LD₅₀ (i.e., the dose required to kill 50% of the population 24 hours post-treatment) of female German cockroaches upon being exposed to a first composition comprising thyme oil but no cinnamon leaf oil and for a second composition comprising cinnamon leaf oil but no thyme oil was determined Both compositions used acetone as a solvent. LD₅₀ was determined by applying a number of different doses to cockroach populations and measuring mortality. The data was analyzed by the probit function to determine the LD₅₀. The source data used in the analysis is shown below in Tables 1 and 2:

TABLE 1
Mortality in German cockroach populations tested to determine
cinnamon leaf oil LD₅₀ by probit analysis.

| Cinnamon Leaf Oil | Cockroaches | | |
|---|---|---|---|
| Dose (mg/insect) | Tested | Number Dead | Mortality (%) |
| 0.1 | 20 | 0 | 0% |
| 0.2 | 24 | 2 | 8% |
| 0.3 | 25 | 1 | 4% |
| 0.4 | 34 | 12 | 35% |
| 0.5 | 24 | 19 | 79% |
| 0.7 | 22 | 18 | 82% |
| 1.0 | 10 | 10 | 100% |
| 2.0 | 10 | 10 | 100% |

TABLE 2
Mortality in German cockroach populations tested to determine
thyme oil LD₅₀ by probit analysis.

| Thyme Oil Dose | Cockroaches | | |
|---|---|---|---|
| (mg/insect) | Tested | Number Dead | Mortality (%) |
| 0.1 | 10 | 0 | 0% |
| 0.2 | 24 | 1 | 4% |
| 0.3 | 24 | 7 | 29% |
| 0.4 | 46 | 37 | 80% |
| 0.7 | 22 | 22 | 100% |
| 1.0 | 10 | 10 | 100% |
| 2.0 | 10 | 10 | 100% |

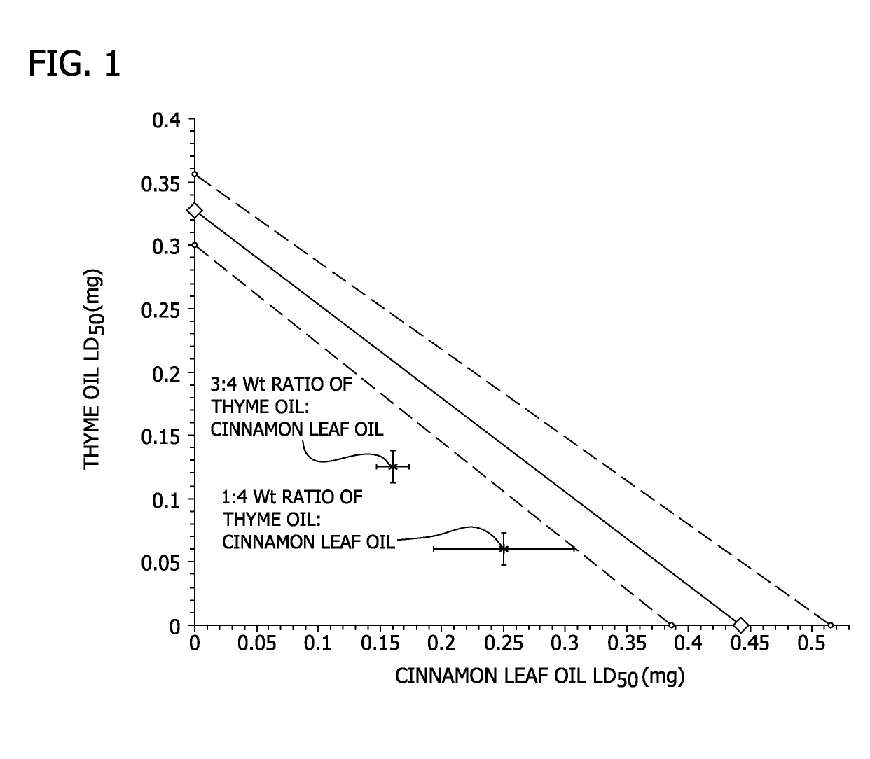

The probit analysis indicated that the LD₅₀ for cinnamon leaf oil was 0.442 mg per insect and the LD₅₀ for thyme oil was 0.328 mg per insect. These values were used to prepare a contour line in an isobologram (FIG. 1) to determine the synergy of mixtures of thyme oil and cinnamon leaf oil described below. The 95% confidence interval contour lines are also shown in FIG. 1 to demonstrate potential statistical error.

The LD₅₀ for female German cockroaches for several mixtures of thyme oil and cinnamon leaf oil in acetone were determined by probit analysis to determine whether thyme oil and cinnamon oil were synergistic when used in combination. The probit analysis was performed separately for each component (i.e., cinnamon leaf oil and thyme oil) in the mixture.

Two mixtures were tested—a first mixture that contained thyme oil and cinnamon leaf oil in a weight ratio equal to the weight ratio of 25% of the LD₅₀ dose for thyme oil to 75% of the LD₅₀ dose for cinnamon leaf oil (which corresponds to about a 1:4 weight ratio of thyme oil to cinnamon leaf oil) and a second mixture that contained thyme oil and cinnamon leaf oil in a weight ratio equal to the weight ratio of 50% of the LD₅₀ dose for thyme oil to 50% of the LD₅₀ dose for cinnamon leaf oil (which corresponds to about a 3:4 weight ratio of thyme oil to cinnamon leaf oil). The source data for the probit analysis is shown in Tables 3 and 4 below.

TABLE 3
Mortality in German cockroach populations tested to determine
the LD₅₀ of a thyme oil and cinnamon leaf oil composition
(1:4 weight ratio) by probit analysis.

| Cinnamon | | | | | |
|---|---|---|---|---|---|
| Leaf Oil | Thyme Oil | | Cock- | | |
| Dose | Dose | Total Dose | roaches | Number | Mortality |
| (mg/insect) | (mg/insect) | (mg/insect) | Tested | Dead | (%) |
| 0.133 | 0.033 | 0.166 | 72 | 7 | 10% |
| 0.232 | 0.057 | 0.289 | 96 | 54 | 56% |
| 0.332 | 0.082 | 0.414 | 96 | 69 | 72% |
| 0.465 | 0.115 | 0.580 | 48 | 35 | 73% |
| 0.830 | 0.164 | 0.994 | 48 | 46 | 96% |
| 0.996 | 0.246 | 1.242 | 24 | 23 | 96% |
| 1.328 | 0.328 | 1.656 | 24 | 24 | 100% |

TABLE 4
Mortality in German cockroach populations tested to determine
the LD50 of a thyme oil and cinnamon leaf oil composition
(3:4 weight ratio) by probit analysis.

| Cinnamon | | | | | |
|---|---|---|---|---|---|
| Leaf Oil | Thyme Oil | | Cock- | | |
| Dose | Dose | Total Dose | roaches | Number | Mortality |
| (mg/insect) | (mg/insect) | (mg/insect) | Tested | Dead | (%) |
| 0.044 | 0.033 | 0.077 | 24 | 0 | 0% |
| 0.088 | 0.066 | 0.154 | 72 | 10 | 14% |
| 0.154 | 0.116 | 0.270 | 72 | 39 | 54% |
| 0.220 | 0.165 | 0.385 | 99 | 67 | 68% |
| 0.308 | 0.227 | 0.535 | 48 | 41 | 85% |

The probit analysis indicated that the LD₅₀ for the 1:4 thyme oil to cinnamon leaf oil composition (25% LD₅₀ dose for thyme oil and 75% LD₅₀ dose for cinnamon leaf oil) was 0.062 mg/insect for thyme oil and 0.251 mg/insect for cinnamon leaf oil. The probit analysis indicated that the LD₅₀ for the 3:4 thyme oil to cinnamon leaf oil composition (50% LD₅₀ dose for thyme oil and 50% LD₅₀ dose for cinnamon leaf oil) was 0.120 mg/insect for thyme oil and 0.161 mg/insect for cinnamon leaf oil.

The LD₅₀ values for the two mixture compositions are shown on the isobologram (FIG. 1). As can be seen from FIG. 1, both the 1:4 thyme oil to cinnamon leaf oil composition (25% LD₅₀ dose for thyme oil and 75% LD₅₀ dose for cinnamon leaf oil) and 3:4 thyme oil to cinnamon leaf oil composition (50% LD₅₀ dose for thyme oil and 50% LD₅₀ dose for cinnamon leaf oil) required less amounts of thyme oil and cinnamon leaf oil to achieve LD₅₀ then would be expected based on their individual contribution to mortality (i.e., both doses for both compositions fall below the contour line) which indicates synergy between thyme oil and cinnamon leaf oil at the tested ratios. The 95% confidence intervals for the data points for both thyme oil (vertical intervals) and cinnamon leaf oil (horizontal intervals) are also shown in FIG. 1. As can be seen, synergy is observed in the entire confidence interval for both thyme oil and cinnamon leaf oil for both compositions.

### Example 2

### Comparison of Mortality Resulting from Exposure to a Pesticide Composition Containing Thyme Oil and Cinnamon Leaf oil and Expected Mortality based on Potency of Individual Components

The LD₅₀ for cinnamon leaf oil and thyme oil were determined as described in Example 1 (0.442 mg per insect for cinnamon leaf oil and 0.328 mg per insect for thyme oil). A pesticide composition containing thyme oil and cinnamon leaf oil was applied to female German cockroaches at a thyme oil dose equal to 50% of the LD₅₀ dose for thyme oil (i.e., 0.165 mg per insect) and a cinnamon leaf oil dose equal to 50% of the LD₅₀ dose for cinnamon leaf oil (0.220 mg per insect) (which corresponds to about a 3:4 weight ratio of thyme oil to cinnamon leaf oil). Several mixtures containing the same 3:4 weight ratio of thyme oil to cinnamon leaf oil but at different doses were also prepared and applied to female German cockroaches. The mortality in each cockroach replicate after being exposed to the respective pesticide composition is shown in Table 5 below. The expected mortality based on the percentage dosage of the LD₅₀ dose is also shown in Table 5.

TABLE 5
Mortality for various compositions containing a 3:4 weight ratio (50%
of each LD₅₀) of thyme oil:cinnamon leaf oil at various doses.

| Percent | Thyme | Cinnamon | Cock- | | | Expected |
|---|---|---|---|---|---|---|
| of LD₅₀ | oil dose | leaf oil dose | roaches | Response | Mortality | Mortality |
| (%) | (mg/insect) | (mg/insect) | Treated | (dead) | (%) | (%) |
| 140 | 0.227 | 0.308 | 12 | 9 | 75% | 70% |
| 140 | 0.227 | 0.308 | 12 | 10 | 83% | 70% |
| 140 | 0.227 | 0.308 | 12 | 10 | 83% | 70% |
| 140 | 0.227 | 0.308 | 12 | 12 | 100% | 70% |
| 120 | 0.198 | 0.264 | 12 | 11 | 92% | 60% |
| 120 | 0.198 | 0.264 | 12 | 11 | 92% | 60% |
| 100 | 0.165 | 0.22 | 12 | 6 | 50% | 50% |
| 100 | 0.165 | 0.22 | 12 | 8 | 67% | 50% |
| 100 | 0.165 | 0.22 | 12 | 11 | 92% | 50% |
| 100 | 0.165 | 0.22 | 12 | 8 | 67% | 50% |
| 100 | 0.165 | 0.22 | 13 | 7 | 54% | 50% |
| 100 | 0.165 | 0.22 | 12 | 9 | 75% | 50% |
| 100 | 0.165 | 0.22 | 14 | 8 | 57% | 50% |
| 100 | 0.165 | 0.22 | 12 | 10 | 83% | 50% |
| 80 | 0.132 | 0.176 | 12 | 8 | 67% | 40% |
| 80 | 0.132 | 0.176 | 12 | 7 | 58% | 40% |
| 70 | 0.116 | 0.154 | 12 | 5 | 42% | 35% |
| 70 | 0.116 | 0.154 | 12 | 9 | 75% | 35% |
| 70 | 0.116 | 0.154 | 12 | 9 | 75% | 35% |
| 70 | 0.116 | 0.154 | 12 | 5 | 42% | 35% |
| 70 | 0.116 | 0.154 | 12 | 6 | 50% | 35% |
| 70 | 0.116 | 0.154 | 12 | 5 | 42% | 35% |
| 60 | 0.099 | 0.132 | 12 | 6 | 50% | 30% |
| 60 | 0.099 | 0.132 | 12 | 9 | 75% | 30% |
| 40 | 0.066 | 0.088 | 12 | 4 | 33% | 20% |
| 40 | 0.066 | 0.088 | 12 | 2 | 17% | 20% |
| 40 | 0.066 | 0.088 | 12 | 0 | 0% | 20% |
| 40 | 0.066 | 0.088 | 12 | 2 | 17% | 20% |
| 40 | 0.066 | 0.088 | 12 | 1 | 8% | 20% |
| 40 | 0.066 | 0.088 | 12 | 1 | 8% | 20% |
| 20 | 0.033 | 0.044 | 12 | 0 | 0% | 10% |
| 20 | 0.033 | 0.044 | 12 | 0 | 0% | 10% |
| 0 | 0 | 0 | 12 | 0 | 0% | 0% |
| 0 | 0 | 0 | 12 | 0 | 0% | 0% |

As can be seen from Table 5, actual mortality was most often greater than the expected mortality based on the individual LD₅₀ doses which indicates synergy between thyme oil and cinnamon leaf oil.

Pesticide compositions containing thyme oil and cinnamon leaf oil were also applied to female German cockroaches at a thyme oil dose equal to 25% of the LD₅₀ dose for thyme oil (i.e., 0.082 mg per insect) and a cinnamon leaf oil dose equal to 75% of the LD₅₀ dose for cinnamon leaf oil (0.332 mg per insect) (which corresponds to about a 1:4 weight ratio of thyme oil to cinnamon leaf oil). Several mixtures containing the same 1:4 weight ratio of thyme oil to cinnamon leaf oil but at different doses were also prepared and applied to female German cockroaches. The mortality in each cockroach population after being exposed to the respective pesticide composition is shown in Table 6 below. The expected mortality based on the percentage dosage of the LD₅₀ dose is also shown in Table 6.

TABLE 6
Mortality for various compositions containing a 1:4 weight ratio (50%
of each LD₅₀) of thyme oil:cinnamon leaf oil at various doses

| Percent | Thyme | Cinnamon | Cock- | | | Expected |
|---|---|---|---|---|---|---|
| of LD₅₀ | oil dose | leaf oil dose | roaches | Response | Mortality | Mortality |
| (%) | (mg/insect) | (mg/insect) | Treated | (dead) | (%) | (%) |
| 400 | 0.328 | 1.328 | 12 | 12 | 100% | 100% |
| 400 | 0.328 | 1.328 | 12 | 12 | 100% | 100% |
| 300 | 0.246 | 0.996 | 12 | 11 | 92% | 100% |
| 300 | 0.246 | 0.996 | 12 | 12 | 100% | 100% |
| 250 | 0.205 | 0.83 | 12 | 11 | 92% | 100% |
| 250 | 0.205 | 0.83 | 12 | 12 | 100% | 100% |
| 200 | 0.164 | 0.664 | 12 | 10 | 83% | 100% |
| 200 | 0.164 | 0.664 | 12 | 9 | 75% | 100% |
| 140 | 0.115 | 0.465 | 12 | 10 | 83% | 70% |
| 140 | 0.115 | 0.465 | 12 | 7 | 58% | 70% |
| 140 | 0.115 | 0.465 | 12 | 10 | 83% | 70% |
| 140 | 0.115 | 0.465 | 12 | 8 | 67% | 70% |
| 100 | 0.082 | 0.332 | 12 | 10 | 83% | 50% |
| 100 | 0.082 | 0.332 | 12 | 11 | 92% | 50% |
| 100 | 0.082 | 0.332 | 12 | 9 | 75% | 50% |
| 100 | 0.082 | 0.332 | 12 | 7 | 58% | 50% |
| 100 | 0.082 | 0.332 | 12 | 7 | 58% | 50% |
| 100 | 0.082 | 0.332 | 12 | 8 | 67% | 50% |
| 100 | 0.082 | 0.332 | 12 | 9 | 75% | 50% |
| 100 | 0.082 | 0.332 | 12 | 8 | 67% | 50% |
| 70 | 0.057 | 0.232 | 12 | 8 | 67% | 35% |
| 70 | 0.057 | 0.232 | 12 | 7 | 58% | 35% |
| 70 | 0.057 | 0.232 | 12 | 4 | 33% | 35% |
| 70 | 0.057 | 0.232 | 12 | 6 | 50% | 35% |
| 70 | 0.057 | 0.232 | 12 | 5 | 42% | 35% |
| 70 | 0.057 | 0.232 | 12 | 8 | 67% | 35% |
| 70 | 0.057 | 0.232 | 12 | 9 | 75% | 35% |
| 70 | 0.057 | 0.232 | 12 | 7 | 58% | 35% |
| 40 | 0.033 | 0.133 | 12 | 2 | 17% | 20% |
| 40 | 0.033 | 0.133 | 12 | 2 | 17% | 20% |
| 40 | 0.033 | 0.133 | 12 | 0 | 0% | 20% |
| 40 | 0.033 | 0.133 | 12 | 1 | 8% | 20% |
| 40 | 0.033 | 0.133 | 12 | 1 | 8% | 20% |
| 40 | 0.033 | 0.133 | 12 | 1 | 8% | 20% |
| 0 | 0 | 0 | 12 | 0 | 0% | 0% |
| 0 | 0 | 0 | 12 | 1 | 8% | 0% |
| 0 | 0 | 0 | 12 | 0 | 0% | 0% |

As can be seen from Table 6, actual mortality was most often greater than the expected mortality based on the individual LD₅₀ doses which indicates synergy between thyme oil and cinnamon leaf oil.

### Example 3

### Preparation of a Concentrate Composition Containing Thyme Oil and Cinnamon Leaf Oil

A concentrate pesticide composition that forms a well dispersed and well mixed diluted pesticide (i.e., that formed a micro-emulsion with the active ingredients being dispersed in an aqueous continuous phase) was prepared. The composition was also found to stay well dispersed in its concentrate form. The concentrate composition that was prepared contained the relative amounts of ingredients shown in Table 7 below. The composition was prepared by adding all ingredients to a container and blending.

TABLE 7
Concentrate composition prepared in accordance with Example 3.

| | Weight | |
|---|---|---|
| Component | Composition (%) | Volume (ml) |
| Coconut Fatty Acid | 30 | 1.506 |
| Isopropyl Alcohol | 15 | 0.956 |
| Ethyl Lactate | 15 | 0.728 |
| Cinnamon Leaf Oil | 30 | 1.440 |
| Thyme Oil | 10 | 0.540 |
| Total | — | 5.170 |

It should be noted that the composition may be preferably formulated without ethyl lactate as ethyl lactate hydrolyzes upon contact with water.

### Example 4

### Efficacy Comparison between a Pesticide Composition Containing Thyme Oil and Cinnamon Leaf Oil and Other Formulations

The composition prepared as described in Example 3 was diluted by addition of water until the diluted composition contained the concentrate composition at a concentration of 10 vol %. Two additional concentrate compositions were also prepared followed by dilution to 10 vol %. The comparative concentrate compositions are shown in Table 8 below.

TABLE 8
Concentrate compositions of Comparative Formulation 1 and Comparative
Formulation 2.

| Comparative Formulation 1 | | Comparative Formulation 2 | |
|---|---|---|---|
| | Weight | | Weight |
| Component | Composition (%) | Component | Composition (%) |
| Coconut Fatty | 26 | Coconut Fatty | 30 |
| Acid | | Acid | |
| Water (DI) | 30.5 | Isopropyl | 15 |
| | | Alcohol | |
| Isopropyl Alcohol | 13.5 | Ethyl Lactate | 15 |
| Cinnamon Leaf | 30 | Cinnamon Leaf | 30 |
| Oil | | Oil | |
| — | — | Spearmint Oil | 10 |

After dilution, each composition was applied to two populations of twelve (12) female German cockroaches. Each cockroach was contacted with 9 μl of the respective concentration composition. The number of immobilized cockroaches after exposure are shown in Table 9 below.

TABLE 9
Number of Immobilized Cockroaches after Exposure to Comparative Formulations
and Formulations Containing Cinnamon Leaf Oil and Thyme Oil

| | Comparative Example 1 | | Comparative Example 2 | | Formulation of | |
|---|---|---|---|---|---|---|
| | Formulation | | Formulation | | Example 3 | |
| Elapsed | Population | Population | Population | Population | Population | Population |
| Time | Immobilized | Immobilized | Immobilized | Immobilized | Immobilized | Immobilized |
| (hr:min) | (n) | (n) | (n) | (n) | (n) | (n) |
| 1:25 | 5 | 4 | 1 | 4 | 7 | 8 |
| 2:20 | 3 | 3 | 1 | 5 | 7 | 8 |
| 3:20 | 2 | 3 | 1 | 5 | 7 | 7 |
| 18:50 | 1 | 3 | 1 | 3 | 6 | 8 |
| 21:45 | 1 | 3 | 1 | 4 | 6 | 7 |
| 24:10 | 1 | 3 | 1 | 4 | 6 | 6 |

| | | | |
|---|---|---|---|
| Total | 4/24 | 5/24 | 12/24 |

### Example 5

### Efficacy of a Pesticide Composition Containing Thyme Oil and Cinnamon Leaf Oil on Various Arthropod Species

Several diluted thyme oil and cinnamon leaf oil-containing compositions were applied to various arthropod species. The composition of the formulations (before dilution) is shown in Table 10 below.

TABLE 10
Concentrate Composition tested for Efficacy in accordance
with Example 5.
Formulation of Example 5

| Component | Weight Composition (%) |
|---|---|
| Cinnamon Leaf Oil | 30 |
| Thyme oil | 10 |
| Coconut Fatty Acid | 45 |
| Isopropyl Alcohol | 15 |

The composition was applied at three different dilution rates (2 oz/gal, 4 oz/gal or 8 oz/gal). The mortality in each species population is shown in Table 11 below.

TABLE 11
Insect mortality for various arthropods tested to determine efficacy of the
formulation of Table 10.

| | Efficacy % | Efficacy % | Efficacy % |
|---|---|---|---|
| | dead @ 24 h | dead @ 24 h | dead @ 24 h |
| | (48 h) | (48 h) | (48 h) |
| Test species | 2 oz./gal | 4 oz./gal | 8 oz./gal |
| Ants, Argentine | not tested | 100 | 100 |
| Ants, Carpenter ants | 2 | 10 | 94 |
| (Camponotus modoc) | | | |
| Ants, Carpenter ants \| | 0 | 0 | 5 |
| (C. pennsylvanicus) | | | |
| Ants, Fire ants | 100 | 100 | 100 |
| Ant, Southern Fire Ant | 100 | not tested | not tested |
| Bed Bugs - Field Strain | 33 (45) | 88 (93) | 75 (78) |
| Bee, honeybee | 100 | 100 | 100 |
| Beetles, Black Carpet beetle | not tested | 50 (33) | 85 (100) |
| (Attagenus unicolor) | | | |
| Beetles, Confused (or red) | 68 | 87 | 100 |
| flour | | | |
| beetles (Tribolium) | | | |
| Beetles, Rice weevil | 63 | 38 | 53 |
| (Sitophilus) | | | |
| Beetles, Sawtoothed grain | 90 | 75 | 100 |
| beetle | | | |
| Beetles, Japanese beetle adults | 100 | 100 | 100 |
| Beetles, Rice weevils | 33 (98) | 20 (90) | 30 (100) |
| Centipedes | 50 | 80 | 100 |
| (Scolopendra polymorpha) | | | |
| Cockroach, American | not tested | 44 | 80 |
| Cockroach, American | 20 | 37 | 73 |
| Cockroach, German | 0 | 10 | 23 |
| Cockroach, German | 0 | 0 | 27 |
| Cockroach, Oriental | 3 | 17 | 70 |
| Cockroaches, Asian | | | |
| Cockroaches, Brown-Banded | 35 | 78 | 100 |
| Cockroaches, Smokeybrown | 0 | 0 | 36 |
| Cockroaches, Turkestan | 13 | 27 | 80 |
| Crickets, House | not tested | 96 | 96 |
| Earwigs | 100 | not tested | not tested |
| Earwigs | 0 | 23 | 45 |
| Flea, Cat | 33 | 89 | 81 |
| Flea, Cat | 100 | 100 | 100 |
| Flies, House - adults | 100 | 100 | 100 |
| Flies, House - larvae | 0 | 0 | 0 |
| Flies, Stable - adults | 93 | 100 | 100 |
| Millipedes | 100 | 100 | 100 |
| Mosquitoes (Aedes) | 100 | not tested | not tested |
| Mosquitoes | 100 | 100 | 100 |
| (Culex quinquefasciatus) | | | |
| Scorpions | 0 | 0 | 40 |
| Silverfish (incl. Firebrats) | 100 | 100 | 100 |
| Sowbugs | 100 | not tested | not tested |
| Sowbugs | 100 | 100 | 100 |
| Spiders- House | 12 | 12 | 32 |
| Spiders - Cellar | not tested | 15 | 100 |
| Ticks, Brown dog tick | 12 | 0 | 20 |
| Wasps, Yellow jackets | not tested | not tested | 100 |

As can be seen from Table 11, the tested formulation exhibited efficacy for a variety of arthropod species.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatus and methods without departing from the scope of the disclosure, it is intended that all matter contained in the above description and shown in the accompanying figures shall be interpreted as illustrative and not in a limiting sense.

1. A pesticide composition for use in controlling crawling insects, the pesticide composition comprising a plurality of active ingredients including a first active ingredient selected from thyme oil, thymol, carvacrol and mixtures thereof and a second active ingredient selected from cinnamon oil, eugenol, cinnamic aldehyde and mixtures thereof, and further comprising a surfactant in an amount of at least about 40 wt %, wherein at least about 33 wt % of the active ingredients are one or more first active ingredients and one or more second active ingredients.

2. The pesticide composition as set forth in claim 1 wherein the first active ingredient consists of thyme oil and the second active ingredient consists of cinnamon oil.

3. The pesticide composition as set forth in claim 1 wherein the pesticide composition is a concentrate and contains less than about 3 wt % water or even no amount of water.

4. The pesticide composition as set forth in claim 3 wherein the surfactant is coconut fatty acid.

5. The pesticide composition as set forth in claim 1 wherein the pesticide composition comprises a co-solvent.

6. The pesticide composition as set forth in claim 1 wherein at least about 50 wt % of the active ingredients in the composition are one or more first active ingredients and one or more second active ingredients or at least about 75 wt %, at least about 90 wt % of the active ingredients in the composition are one or more first active ingredients and one or more second active ingredients.

7. The pesticide composition as set forth in claim 1 wherein the pesticide composition comprises a first active ingredient and a second active ingredient in a weight ratio at which the composition is synergistic.

8. The pesticide composition as set forth in claim 7 wherein the weight ratio of first active ingredients to second active ingredients is less than about 1:1 or from about 1:6 to about 1:1.

9. A method for controlling crawling insects, the method comprising applying a pesticide composition to a crawling insect, the pesticide composition comprising a plurality of active ingredients including a first active ingredient selected from thyme oil, thymol, carvacrol and mixtures thereof and a second active ingredient selected from cinnamon oil, eugenol, cinnamic aldehyde and mixtures thereof; and further comprising a surfactant in an amount of at least about 40 wt %, wherein at least about 33 wt % of the active ingredients are one or more first active ingredients and one or more second active ingredients, the composition being capable of killing crawling insects after contact.

10. The method as set forth in claim 9 wherein the first active ingredient consists of thyme oil and the second active ingredient consists of cinnamon oil.

11. The method as set forth in claim 9 comprising diluting a concentrate composition to produce the pesticide composition prior to application of the pesticide composition, the concentrate composition comprising a plurality of active ingredients including a first active ingredient and a second active ingredient, wherein at least about 33 wt % of the active ingredients are one or more first active ingredients and one or more second active ingredients.

12. The method as set forth in claim 9 wherein the crawling insect is selected from the group consisting of cockroaches, ants, beetles, earwigs, spiders, pillbugs, sowbugs, centipedes, millipedes and firebrats.

13. The method as set forth in claim 9 wherein the pesticide composition comprises a first active ingredient and a second active ingredient in a weight ratio at which the composition is synergistic.

14. The method as set forth in claim 13 wherein the weight ratio of first active ingredients to second active ingredients is less than about 1:1 or from about 1:6 to about 1:1.

15. A pesticide composition for use in controlling crawling insects, the pesticide composition comprising a plurality of active ingredients including a first active ingredient selected from thyme oil, thymol, carvacrol and mixtures thereof and a second active ingredient selected from cinnamon oil, eugenol, cinnamic aldehyde and mixtures thereof, and further comprising a surfactant, wherein at least about 75 wt % of the active ingredients are one or more first active ingredients and one or more second active ingredients, and wherein the surfactant is coconut fatty acid.

16. A method for controlling crawling insects, the method comprising applying a pesticide composition to a crawling insect, the pesticide composition comprising a plurality of active ingredients including a first active ingredient selected from thyme oil, thymol, carvacrol and mixtures thereof and a second active ingredient selected from cinnamon oil, eugenol, cinnamic aldehyde and mixtures thereof, and further comprising a surfactant, wherein at least about 75 wt % of the active ingredients are one or more first active ingredients and one or more second active ingredients, and wherein the surfactant is coconut fatty acid, the composition being capable of killing crawling insects after contact.
